(19) United States
(12) Patent Application Publication
(10) Pub. No.: US 2025/0150739 A1
(43) Pub. Date: May 8, 2025

(54) SPEAKER STAND AND APPARATUS

(71) Applicant: Jolly Innovation Technology Co., Ltd., Guangzhou (CN)

(72) Inventor: Li Xiao, Shenzhen (CN)

(21) Appl. No.: 18/934,451

(22) Filed: Nov. 1, 2024

(30) Foreign Application Priority Data
Nov. 2, 2023 (CN) 202322967916.1

(51) Int. Cl. H04R 1/02; F16M 11/04; F16M 11/28

(52) U.S. Cl. CPC H04R 1/026; F16M 11/041; F16M 11/28

(57) ABSTRACT

The present disclosure provides a speaker stand. The speaker stand is used to clamp and support speakers, and comprises: a seat configured for receiving a speaker, the seat comprising a loading member configured for loading the speaker, a first engaging member attached to a first side of the loading member, and a second engaging member attached to a second side of the loading member, each of the first engaging member and the second engaging member capable of engaging with the speaker which is loaded on the loading member; and a support post configured for connecting to the loading member; wherein, at least one of the first engaging member and second engaging member is movable relative to the loading member, the first engaging member and second engaging member are opposite to each other, a distance between the first engaging member and the second engaging member is adjustable.

### TECHNICAL FIELD

The present disclosure relates to the field of supporting mechanism, and specifically relates to a speaker stand and an apparatus.

### BACKGROUND

Speakers are important audio equipment and have been widely used in home and commercial environment. Speakers usually need to be disposed at a specific location for better sounds effects. The speakers are thus usually placed at different specific heights according to the usage scenarios. Therefore, an adjustable speaker stand is required to adjust the height of each of the speakers.

### BRIEF DESCRIPTION OF DRAWINGS

In order to illustrate the technical solution in embodiments of the present invention more clearly, the following briefly introduces accompanying drawings used in the description of the embodiments. Obviously, the accompanying drawings in the following description are only some embodiments of the present invention. Those of ordinary skill in the art can obtain other accompanying drawings from these accompanying drawings without any creative efforts.

FIG. 1 is a perspective view of a first embodiment of a speaker stand of the present disclosure.

FIG. 2 is a partially enlarged view of the speaker stand shown in FIG. 1.

FIG. 3 is an exploded view of a seat of the speaker stand.

FIG. 4 is an exploded view of the seat shown in FIG. 3, viewed from another viewing direction.

FIG. 5 is a view illustrating a scale strip accommodated in a loading member.

FIG. 6 is an orthographic view of the seat of the speaker stand, viewed from a top side.

FIG. 7 is an orthographic view of the seat of the speaker stand, viewed from a bottom side.

FIG. 8 is a view illustrating a speaker held by the speaker stand shown in FIG. 1.

### DETAILED DESCRIPTION

The structure of the existing speaker stand generally includes a base, a hollow main rod, a telescopic rod, and an support base. The telescopic rod can be inserted into the main rod in a telescopic manner, and the support base is installed at the top of the telescopic rod. When the telescopic rod does not need to be extended or retracted, the telescopic rod is locked on the main rod via the locking knob. However, the current speaker stand on the market has poor clamping effects and generally pose security hazard such as tipping and tilting. That is to say, the speaker is at risk of falling. In addition, most existing speaker stands cannot adjust the distance between the two side clamps, making them unsuitable for a variety of varied sizes of speakers. Additionally, their fixing effect on irregular speakers is not satisfactory.

The following will provide a clear and complete description of the technical solution in the embodiments of the present application, based on the accompanying drawings. Obviously, the described embodiments are only a part of the embodiments of the present application, not the entire embodiments. Based on the embodiments described in this application, all other embodiments obtained by ordinary skilled persons in this field without creative labor are within the scope of protection of this application.

In addition, the terms “first” and “second” are only used to distinguish components and cannot be understood as indicating or implying relative importance or indicating the quantity of technical features.

Below, with reference to the accompanying drawings, a further detailed description of the specific implementation of the present application will be provided.

### First Embodiment

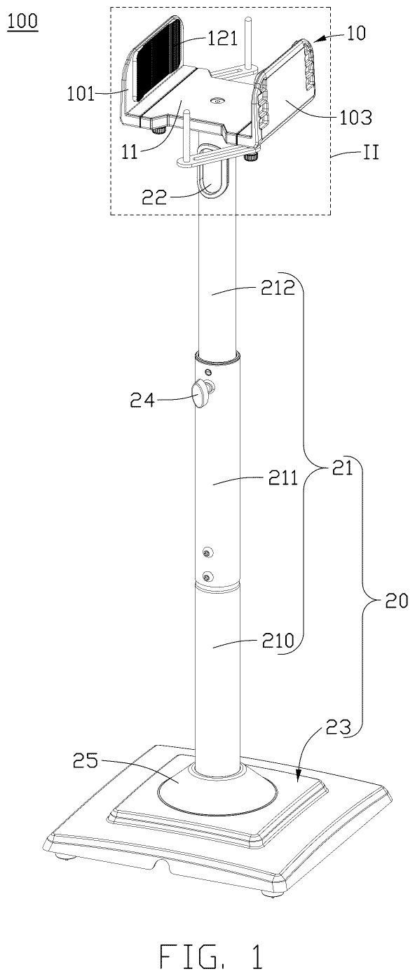

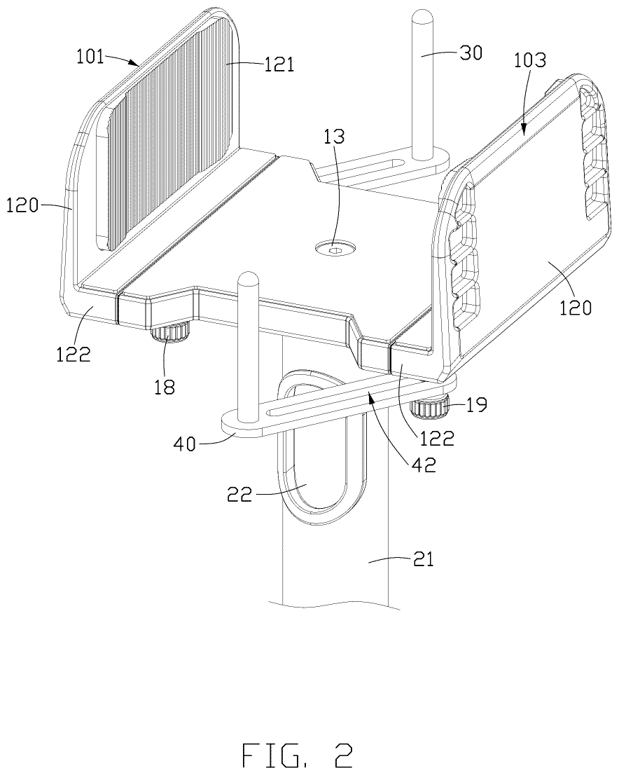

As shown in FIG. 1 and FIG. 2, a speaker stand 100 may include a seat 10 and a support member 20 fixedly connected to the seat 10 to support the seat 10 at a special height. The special height may be varies according to needs.

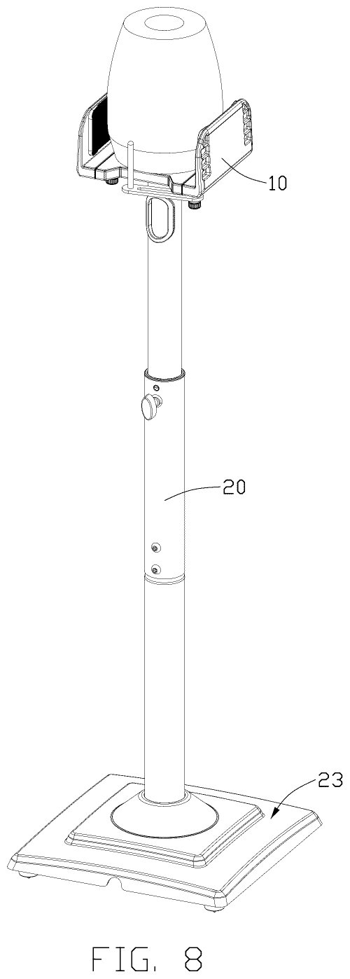

The seat 10 is configured to place and fasten an object thereon. The object may be a speaker (shown in FIG. 8). The speaker can have a regular shape such as a rectangular prism, a cube, etc. It can also be an alien box. The seat 10 includes a loading member 11, a first engaging member 101 and a second engaging member 103. The loading member 11 may be a rectangle flat. The object may be placed on the loading member 11 and fastened by a cooperation of the first engaging member 101 and the second engaging member 103. The first engaging member 101 and the second engaging member 103 are vertically connected to opposite sides of the loading member 11, such as a left side and a second side. The loading member 11 cooperates with the first and second engaging members 101, 103 to define an accommodating space (not labeled) for accommodating the speaker. The first engaging member 101 cooperates with the second engaging member 103 to fasten the speaker along a first direction. The first direction may be an extending direction of the loading member 11. An upper surface of the loading member 11 is a smooth surface which is capable of directly contacting a bottom surface of the speaker. In the other embodiment, the seat 10 may further include a flexible cover, such as a rubber pad, covering the upper surface of the loading member 11 to increase the frictions between the seat 10 and the speaker. In addition, the flexible cover can act as a buffer between the seat 10 and the speaker to prevent the speaker from be damaged by the seat 10 during installation.

The support member 20 includes a support post 21 and a base 23 attached to a lower end of the support post 21. In this embodiment, the support post 21 has a telescopic mechanism. A top end of the support post 21 is connected to a bottom surface of the loading member 11, and the lower end of the support post 21 is fastened at a center of the base 23 by an engagement of a flange 25 and screws (not shown). The length of the support post 21 is adjustable, so as to adjust the distance between the seat 10 and the base 23.

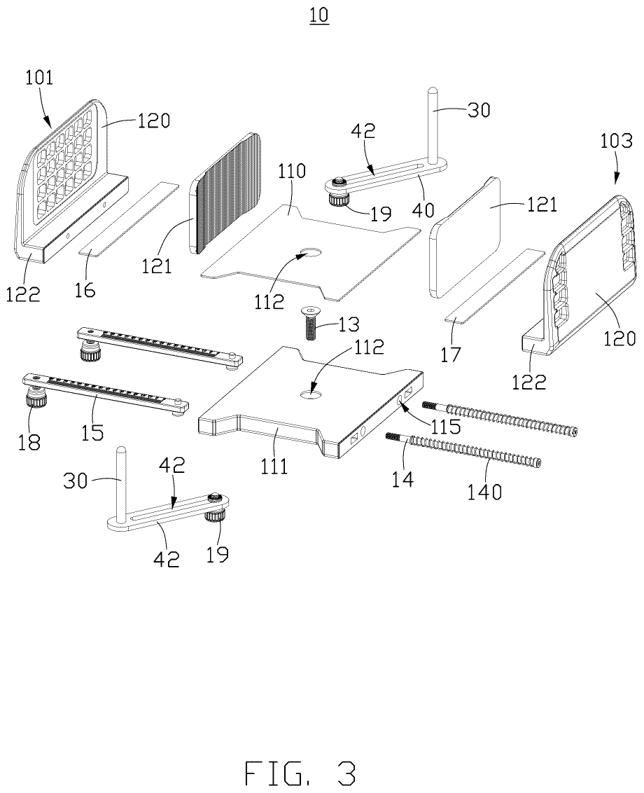

Please also refer to FIGS. 3, 4, and 5. The loading member 11, which is roughly rectangular in shape, includes an upper plate 110 and a lower plate 111 covered by the upper plate 110. Each of the first engaging member 101 and the second engaging member 103 includes a sidewall 120 and a connecting portion 122 approximately perpendicularly connected to the sidewall 120. The two connecting portions 122 are arranged in a same plane with the loading member 11. The end walls of the two connecting portions 122 respectively butt against end walls of the loading member 11 and align with the end walls of the loading member 11. Preferably, the sidewall 120 and the connecting portion 122 of each of the first engaging member 101 and the second engaging member 103 are integrally formed.

The upper plate 110 and the lower plate 111 are completely overlapped. Each of the upper plate 110 and the lower plate 111 defines an installation hole 112 at a center thereof for installing a fastener 13. The center of the lower plate 111 forms a fastening portion 113. The upper end of the support post 21 is sleeved around the fastening portion 113. The fastener 13 is screwed onto the support post 21 with penetrating through the fastening portion 113. Multiple concaves (not labeled) are formed in the lower plate 111 and/or the fastening portion 113 to reduce the overall weight of the loading member 11.

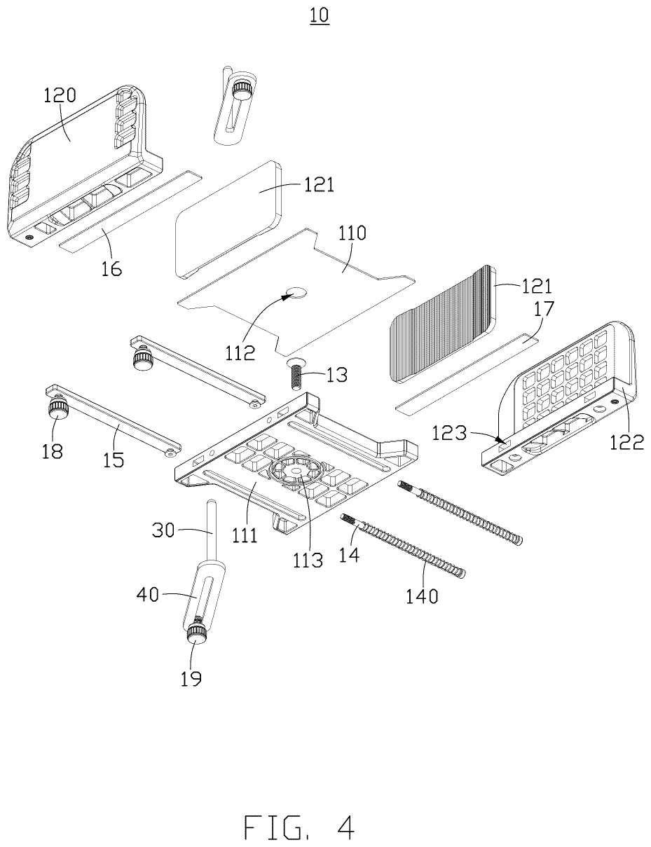

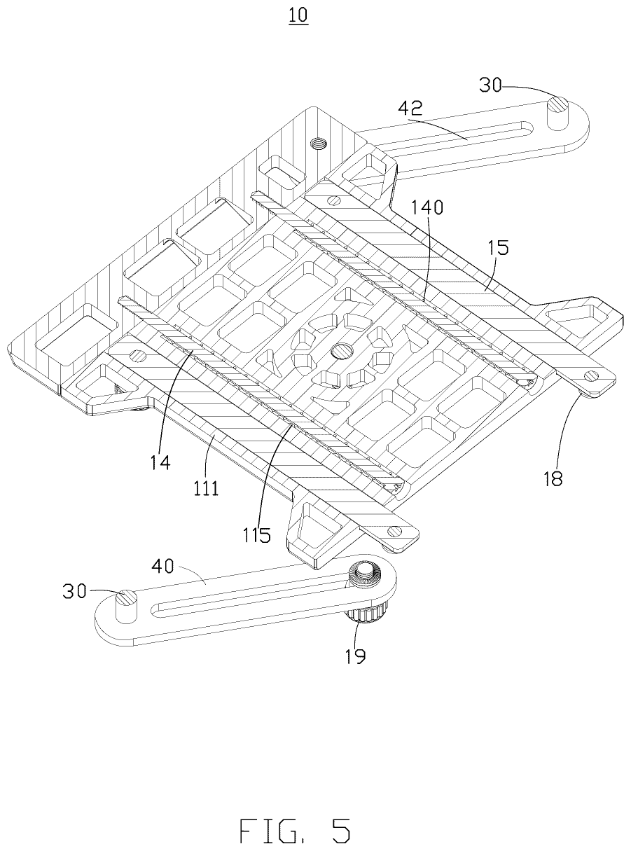

As shown in FIG. 4 and FIG. 5, two screw shafts 14 and two scale strips 15 are received between the upper plate 110 and the lower plate 111. The lower plate 111 includes an upper surface which defines two grooves 115 penetrating the lower plate 111 along the first direction for accommodating the two screw shafts 14 therein. The length of each screw shaft 14 is greater than that of the corresponding groove 115, so that at least a portion of each screw shaft 14 protrudes out of an end of the corresponding groove 115. Each screw shaft 14 includes a thread portion and a non-thread portion. An elastic component 140, for example a spring, is sleeved around the non-thread portion of each screw shaft 14. The elastic component 140 is compressed to apply an elastic force on the screw shaft 14 to move the screw shaft 14 towards the loading member 11 together with the first engaging member 101. The thread portion protrudes out of the elastic component 140. An assembly of each of the screw shaft 14 and the elastic component 140 is slidably received in the corresponding groove 115. The diameter of a portion of the groove 115 corresponding to the thread portion of the screw shaft 14 is smaller than that of another portion of the groove 115 corresponding to the elastic component 140, thereby forming a stopper portion (not labeled) for stopping the elastic component 140 in the groove 115. The two screw shafts 14 are disposed to be parallel to the first direction. Each screw shaft 14 has a first end and a second end opposite with the first end. The first end protrudes out of the groove and is capable of being inserted into the connecting portion 122 of the first engaging member 101. The second end is disposed to expose to outside for being operated by user. The loading member 11 further includes a first mounting plate 16 on the connecting portion 122 of the first engaging member 101 and a second mounting plate 17 on the connecting portion 122 of the second engaging member 103. The first ends of the two screw shafts 14 insertable into the connecting portion 122 are located below the first mounting plate 16. The first mounting plate 16 is mounted on an upper surface of the connecting portion 122 of the first engaging member 101. The first engaging member 101 is pushed to move relative to the lower plate 111 together with the first mounting plate 16 by the drive of the movement of the screw shaft 14.

The two scale strips 15 are parallel to the two screw shafts 14 with the screw shafts 14 being located between the two scale strips 15. The two scale strips 15 are disposed at the loading member 11, and being configured for pushing the second engaging member 103 to move relative to the loading member 11. An upper surface of each scale strips 15 is scaled with scales for measuring. The first end of each of the scale strips 15 is engaged into the engagement holes 123 of the connecting portion 122 of the second engaging member 103. The second end of each of the scale strip 15 is located near the connecting portion 122 of the first engaging member 101.

The bottom surface of the loading member 11 defines openings 114 corresponding to the scale strips 15. The shape of each opening 114 is designed to expose the scales of each scale strip 15. The opening 114 extends along the first direction and penetrates through the lower plate 111 from a bottom side to a top side. A first fixing knob 18 is fastened to the second end of each scale strip 15, for locking the scale strip 15 in the desired position in the loading member 11. Each first fixing knob 18 includes a handle extending out of opening 114 at the bottom side of the loading member 11. The first fixing knob 18 can move in the opening 114 by pushing from the handle. In another words, the scale strip 15 is driven by the first fixing knob 18 and moves in the openings 114, so that a guide rail structure is formed for pushing the second engaging member 103 connected to the scale strip 15 to move forward and backward. The second engaging member 103 connected to the first end of the scale strip 15 is thus driven to close to and apart from the loading member 11. In addition, the first fixing knobs 18 are capable of locking the two scale strips 15 at desired positions. The user can read the scales on the scale strips 15 from gaps between the lower plate 11 and the connecting portion of the second engaging member 103.

Each of the first engaging member 101 and the second engaging member 103 includes a lining plate 121. The lining plates 121 face the accommodating space and installed on opposite surfaces of the sidewalls 120 by bonding or other means. The shape and size of the lining plates 121 match those of the sidewall 120. Preferably, the lining plates 121 have a greater friction coefficient than that the opposite surfaces of the sidewalls 120. The lining plates 121 may be made of a rubber material, so as to increase the friction between the seat 10 and the speaker.

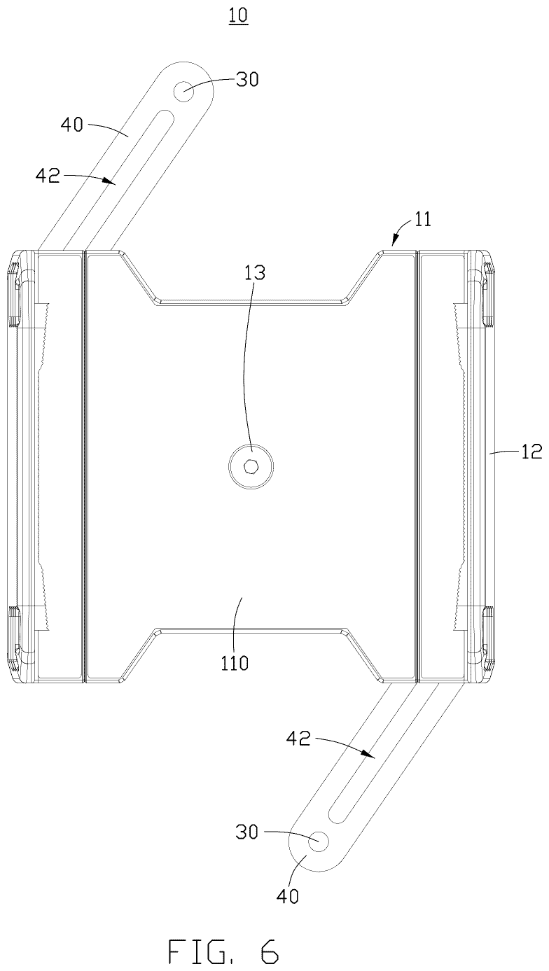

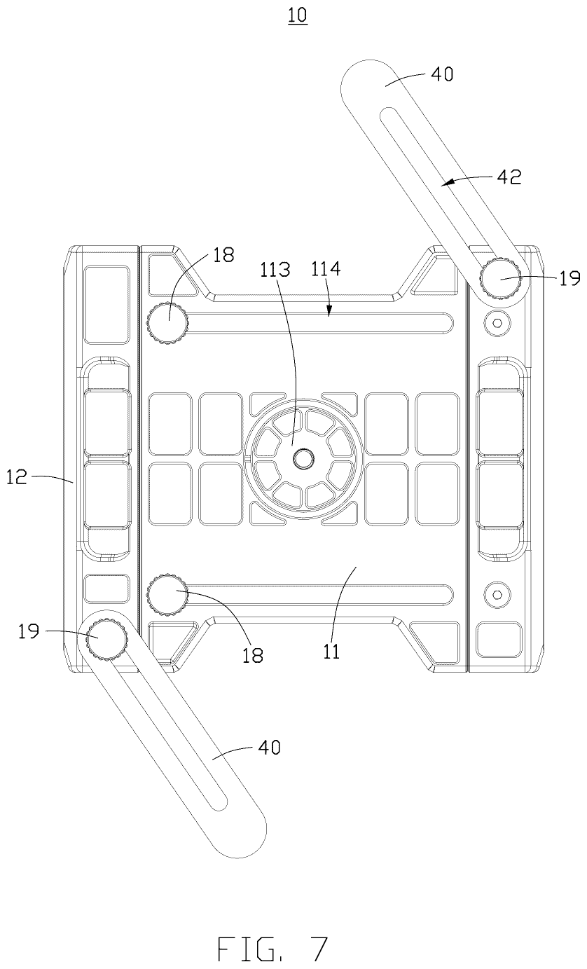

As shown in FIG. 6 and FIG. 7, when the seat 10 is in an original state, the two screw shafts 14 and two scale strips 15 pass through the lower plate 111 of the loading member 11 along the first direction. The first end of each screw shaft 14 is inserted and fixed in the connecting portion 122 of the first engaging member 101. The first end of each scale strip 15 is inserted into the engagement hole 123 of the second engaging member 103. The first mounting plate 16 and the second mounting plate 17 are fixed on the upper surfaces of the connecting portions 122 of the first engaging member 101 and the second engaging member 103 by bonding or other methods with covering the first ends of the screw shafts 14 and the scale strips 15. The upper plate 110 are arranged on an assembly of the lower plate body 111, the screw shafts 14 and the scale strips 15.

Please also refer to FIG. 8, when using the speaker stand 100 to support the speaker, the size of the accommodating space and/or the height of the seat are adjustable based on the size and/or position of the speaker.

When the speaker has a first length which is smaller than that of an original length of the accommodating space at the first direction, both of the first engaging member 101 and the second engaging member 103 are at their original locations. When the speaker has a second length which is larger than the original length but smaller than a certain value, it is usually only necessary to adjust the first engaging member 101. Specifically, when the first engaging member 101 inserted with the first ends of the screw shafts 14 is pulled away from the loading member 11 by a user, the first engaging member 101 drives the two screws shafts 14 to move out of the interior of the loading member 11. During this process, one end of the elastic component 140 wound around the outer periphery of the screw shaft 14 is stopped on the stop wall of groove 115, thereby being compressed and accumulating elastic potential energy. When the first engaging member 101 is pulled away to a furthest location, the elastic component 140 is compressed to the shortest length and has a maximum elastic force. When the user releases the first engaging member 101, the first engaging member 101 moves backward towards the loading member 11 to its original location under the elastic force of the elastic component 140, thereby clamping the speaker between the first and second engaging member 101 and 103. It can be understood that, the certain value and the movement distance of the first engaging member 101 relative to the loading member 11 are predefined according to the size of the speaker.

When the speaker has a third length which is larger than the certain value, it is necessary to adjust both of the first and second engaging members 101, 103, so that both of the first and second engaging members 101, 103 move away from the loading member 11. Specifically, first, the user can roughly measure the bottom length of the speaker by eyes or accurately measure the bottom length of the speaker using measuring tools. Secondly, rotate and release the two first fixing knobs 18 from the bottom of the seat 10, so that the scale strips 15 can move in the narrow opening 114 along the first direction. Afterwards, pull the second engaging member 103 that is fixed to the scale strips 15 and move it away from the loading member 11. At this time, the scale strips 15 are pulled out from the loading member 11 along with the movement of the second engaging member 103, user can watch the scales on the scale strips 15 and then adjust the extension of the scale strips 15. Finally, lock the scale strips 15 at adjusted locations using the first fixing knob 18. During the process of placing the speaker, the first engaging member 101 located on the other side is pushed outward by the speaker or pulled by the user, and moves outward an appropriate distance. After the speaker is received into the accommodating space, the first engaging member 101 is pulled by the elastic component 140, thereby firmly clamping the speaker between the first and second engaging members 101 and 103, thereby preventing it from tipping over.

It can be understood that, there is another installation method available. There is, after pulling the second engaging member 103 fixed to the scale strip 15 to the desired position, then pull the first engaging member 101 connected to the elastic component by hand to move it to the position where the speaker can be placed, and then place the speaker into the seat 10. At this moment, the first engaging member 101 is pulled by the elasticity, thereby clamping the speaker and firmly storing it in the accommodating space of the seat 10.

The support post 21 includes a lower post 210 connected to the base 23, a middle post 211 connected to the lower post 210, and an upper post 212 connected to the middle post. Each of the lower post 210, middle post 211, and upper post 212 is a hollow-shaped tube. They can be metal, plastic, or wood, etc. The lower post 210 and the middle post 211 are connected by screws or other means, and their positions are relatively fixed after assembly. At least a portion of the upper post 212 is insertable into the middle post 211. The upper post 212 is slidable relative to the middle post 211 for adjusting the height of the upper post 212 extending out of the middle post 211. Specifically, an adjustment knob 24 is provided at the connection point of the middle post 211 and the upper post 212. By adjusting the screw of knob 24, the upper post 212 can be fixed at different positions relative to the middle post 211. By this way, the extension distance of the upper post 212 relative to the middle post 211 can be adjusted, the height of the entire support post 21 is changeable. The upper end of the upper post 212 also has an elliptical opening 22. The opening 22 can reduce the weight of the upper post 212 and facilitate users to grip the support post 21, and adjust the length of the support post 21 by pulling.

The base 23 can be a board made of hard resin, wood, or materials such as tempered glass. The bottom end of the lower post 210 is welded with the flange 25, which is fixed to the base 23 by screws or the like. In addition, there are four protrusions at the four corners of a bottom surface of the base 23, which are used to adapt to different levels of flatness on the ground, keep the support post 21 stable, and play a role in anti-slip.

In one embodiment, both the first engaging member 101 and the second engaging member 103 can move relative to the loading member 11. The movement distance of the second engaging member 103 relative to the loading member 11 is greater than the movement distance of the first engaging member 101 relative to the loading member 11. In this variation, the two scale strips 15 are designed to be longer compared to the lengths of the two screws shafts 14 and the elastic component 140 around it. Thereby, each of the first engaging member 101 and the second engaging member 103 is movable relative to the loading member 11, a maximum movement distance of the second engaging member 103 relative to the loading member 11 is greater than a maximum movement distance of the first engaging member 101 relative to the loading member 11.

The speaker stand 200 further includes two stop pins 30 set on the front and rear sides of the seat 10. Specifically, the first engaging member 101 and the second engaging member 103 are movable relative to each other in the first direction, and the two stop pins 30 are movable relative to each other in a second direction for fastening the object in the accommodating space. The second direction is crossed, especially perpendicular, to the first direction. The two stop pins 30 are rotatably attached to different sides of the first/second engaging member 101 and 103. The two stop pins 30 are coupled to the front side of the second engaging member 103 and the rear side of the first engaging member 101 via two connecting pieces 40. In other words, one of the stop pin 30 is located at a third side of the loading member 11; another stop pin 30 is located at a fourth side of the loading member 11, the fourth side being opposite to the third side, wherein the stop pins 30 engages with the speaker for locating the speaker along the second direction. The two stop pins 30 constitutes a first limiting element and a second limiting element respectively. The first limiting element comprises a first pin 30 configured for engaging with the object located on the loading member 11 and a first connecting piece 40 is rotatably attached to one of the loading member 11 and the first engaging member 101, a distance between the loading member 11 and the first pin 30 is adjustable by rotating the first connecting piece 40. The second limiting element comprises a second pin 30 for engaging with the object located on the loading member 11 and a second connecting piece 40 is rotatably attached to one of the loading member 11 and the second engaging member 103, a distance between the loading member 11 and the second pin 30 is adjustable by rotating the second connecting piece 40.

The lower end of each stop pin 30 is vertically fixed on one end of each connecting piece 40. The other end of each connecting piece 40 is installed on a bottom surface of the rear side of the first engaging member 101 or a bottom surface of the front side of the second engaging member 103 through two second fixing knob 19. Each connecting piece 40 is provided with a slot 42. Each second fixing knob 19 has a rod which is installed in the slot 42. The connecting piece 40 is rotatable relative to the rod of the second fixing knob 19 for adjusting the distance between the two stop pins 30. The fixed ends of the two connecting pieces 40 respectively, are diagonally located on the loading member 11 of the seat 10, and the extension directions of the free ends of the two connecting pieces 40 are parallel to each other.

In this embodiment, the first engaging member 101 and the second engaging member 103 of the seat 10 clamp and fix the speaker in the first direction, while the two stop pins 30 limit the speaker at the second direction perpendicular to the first direction. Therefore, the speaker stand 200 can not only hold and fix conventional cube or rectangular shaped speakers, but also be used to hold and fix irregular shaped speakers such as cylindrical, drum shaped (with curved side walls), or hexagonal sections.

The speaker stand has at least the following beneficial effects:

(1) The seat of the speaker stand includes the loading member, two engaging members located on the left and right sides of the loading member, two stop pins located at front and rear sides of the loading member, and the rubber pad adhered to the inner wall of the first/second engaging member. The second engaging member is detachably connected to the loading member via the guide rail assembly (with scales), and the first engaging member is detachably connected to the loading member by the elastic component assembly (with elastic screw). When placing the speaker in the seat, first measure the bottom length of the speaker, then adjust the extension of the guide rail assembly (see the scales), and then lock the scale strips of the guide rail assembly with the adjustment knobs from the bottom of the seat. Pull the first/second engaging member outward for engaging with the speaker to holding the speaker and avoid tipping or falling of the speaker.

(2) After the speaker is sandwiched by the first and second engaging members, the rubber pads on the inner walls of the first and second engaging members increase the friction between the clamping seat and the speaker. This stand has been designed with front and rear stop pins, which can ensure that the speaker will not fall off from the front and rear side. If the speaker is an irregular shaped body or engaging surfaces between the speaker and the first/second engaging member are uneven, the stop pins can provide limit and protection.

The above displays and describes the basic principles, main features, and advantages of the present disclosure. Technicians in this field should understand that, the present disclosure is not limited by the above embodiments. The above embodiments and the description in the specification only illustrate the principles of the present disclosure. Without departing from the spirit and scope of the present disclosure, there will be various changes and improvements to the present disclosure, all of which fall within the scope of protection requirements. The scope of protection required by the present disclosure is defined by the attached claims and their equivalents.

What is claimed is:

1. A speaker stand comprising:
a seat configured for receiving a speaker, and comprising a loading member configured for loading the speaker, a first engaging member attached to a first side of the loading member, and a second engaging member attached to a second side of the loading member, each of the first engaging member and the second engaging member configured for engaging with the speaker which is loaded on the loading member; and
a support post configured for connecting to the loading member,
wherein at least one of the first engaging member and second engaging member is movable relative to the loading member, the first engaging member and second engaging member are opposite to each other, a distance between the first engaging member and the second engaging member is adjustable,
an elastic component is disposed in the loading member, and elastically abutting against the first engaging member such that the first engaging member maintains engaged with the speaker; and,
when the first engaging member is moved away from an original location, the first engaging member cooperates with the second engaging member to load the speaker on the loading member.

2. The speaker stand according to claim 1, wherein each of the first engaging member and the second engaging member is movable relative to the loading member along a first direction, the first engaging member and the second engaging member sandwich the speaker therebetween when any one of the first engaging member and the second engaging member is moved from the original location.

3. The speaker stand according to claim 2, further comprising:
a screw shaft, which is disposed at the loading member and movable relative to the loading member,
wherein the elastic component is sleeved on the screw shaft and elastically deformed by the screw shaft, the screw shaft is fixedly connected with the first engaging member.

4. The speaker stand according to claim 3, further comprising:
a strip disposed at the loading member and configured for pushing the second engaging member to move relative to the loading member;
a fixing member fastened on the strip and configured for locating the strip at a preset location at which the second engaging member is spaced away from the loading member.

5. The speaker stand according to claim 4, further comprising:
another screw shaft attached to the first engaging member and movable relative to the loading member; and
another strip attached to the second engaging member and movable relative to the loading member,
wherein the screw shafts and the strips are disposed in parallel to the first direction.

6. The speaker stand according to claim 5, further comprising:
a first fixing knob fastened to one end of the strip, the first fixing knob being configured for locking the strip in the preset location in the loading member,
the first fixing knob comprising a handle extended out of a bottom of the loading member.

7. The speaker stand according to claim 6, wherein each of the first engaging member and the second engaging member comprises a sidewall and a connecting portion,
the connecting portion is vertically connected to the sidewall and located in a same plane as the loading member, and an end wall of the connecting portion is aligned with an end wall of the loading member,
one end of the screw shaft is inserted and fixed into the connecting portion of the first engaging member;
another end of the strip is fixed in the connecting portion of the second engaging member.

8. The speaker stand according to claim 2, further comprising:
a first stop pin located at a third side of the loading member; and
a second stop pin located at a fourth side of the loading member, the fourth side being opposite to the third side,
wherein each of the first and the second stop pins is configured to engage with the speaker thereby locating the speaker along a second direction, the second direction is different to the first direction.

9. An apparatus comprising:
a seat comprising a loading member configured for loading an object, a first engaging member and a second engaging member, wherein the first engaging member and the second engaging member are located opposite to each other, and configured for cooperatively clamping the object on the loading member in a first direction;
a support post connected to the seat;
a first limiting element movable relative to the loading member; and,
a second limiting element configured for cooperating with the first limiting element to limit movements of the object on the loading member in a second direction,
wherein, the second direction is perpendicular to the first direction.

10. The apparatus according to claim 9, wherein,
the first limiting element comprises a first pin configured for engaging with the object on the loading member; and a first connecting piece rotatably attached to one of the loading member and the first engaging member, a distance between the loading member and the first pin is adjustable by the rotating the first connecting piece;
the second limiting element comprises a second pin configured for engaging with the object on the loading member; and a second connecting piece rotatably attached to one of the loading member and the second engaging member, a distance between the loading member and the second pin is adjustable by rotating the second connecting piece.

11. The apparatus according to claim 10, wherein,
a lower end of the first pin is vertically fixed to an end of the first connecting piece, and another end of the first connecting piece is rotatably mounted on a bottom of the first engaging member;
a lower end of the second pin is vertically fixed to an end of the second connecting piece, and another end of the second connecting piece is rotatably mounted on a bottom of the second engaging member;
the first pin and the second pin can be moved relative to the loading member in a direction away from one another or closer to one another.

12. The apparatus according to claim 11, wherein:
each of the first connecting piece and the second connecting piece defines a slot;
the apparatus further comprises a first knob configured for locking the first pin at a preset location;
a second knob configured for locking the second pin at a preset location,
wherein each of the first knob and the second knob is rotatable in the slot when each of the first connecting piece and the second connecting piece rotates relative to the loading member.

13. The apparatus according to claim 10, wherein fixed ends of the first and the second connecting pieces of the first and the second limiting elements, respectively, are diagonally located on the loading member of the seat, and extension directions of free ends of the first and the second connecting pieces are parallel to each other.

14. A speaker stand comprising:
a seat comprising a loading member configured for supporting at least one speaker;
a first engaging member and a second engaging member are respectively located at opposite sides of the loading member, the first engaging member and the second engaging member are configured to clamp the at least one speaker therebetween,
wherein, each of the first engaging member and the second engaging member is movable relative to the loading member, a maximum movement distance of the second engaging member relative to the loading member is greater than a maximum movement distance of the first engaging member relative to the loading member.

15. The speaker stand according to claim 14, wherein the first engaging member is connected to the loading member and configured to be pulled towards the loading member by an elastic component, and the second engaging member is connected to the loading member via a rail, a portion of the rail extending out of the loading member is adjustable.

16. The speaker stand according to claim 15, further comprising a screw shaft, wherein,
the screw shaft is received in the loading member and fixedly connected to the first engaging member;
the elastic component is disposed around the screw shaft;
when the the first engaging member is pulled away from loading member, the elastic component is compressed to apply an elastic force on the screw shaft, which can move the screw shaft towards the loading member together with the first engaging member.

17. The speaker stand according to claim 15, wherein the rail comprises:
a locking element attached to the loading member; and
a strip movable relative to the loading member,
wherein the locking element is configured for locking the strip at a preset position,
the loading member defines an opening,
the strip is accommodated in the loading member, and fixedly connected to the second engaging member,
the locking element is slidably received in the opening, a portion of the locking element is exposed out of the locking element.

18. The speaker stand according to claim 17, wherein when the first engaging member and the second engaging member are pulled away from the loading member,
the distance of the first engaging member relative to the loading member is adjusted by locking the strip with the first fixing knob from the bottom of the seat; and
the distance of the second engaging member relative to the loading member is adjusted by the elastic restoring force of the elastic component.

19. The speaker stand according to claim 14, wherein,
the speaker stand is configured to support a speaker of a smaller size of the at least one speaker, when the distance between the first engaging member on one side of the seat and the loading member is adjusted;
the speaker stand is configured to support a speaker of a larger size of the at least one speaker, when the distance between the first engaging member and the second engaging member on both sides of the seat are adjusted relative to the loading member.
